(19) United States
(12) Patent Application Publication
(10) Pub. No.: US 2022/0270379 A1
(43) Pub. Date: Aug. 25, 2022

(54) INFORMATION PROCESSING DEVICE, INFORMATION PROCESSING METHOD, AND SYSTEM

(71) Applicant: TOYOTA JIDOSHA KABUSHIKI KAISHA, Toyota-shi (JP)

(72) Inventors: Hiroyasu HADANO, Toyota-shi (JP); Tatsunori KATOH, Nagoya-shi (JP)

(73) Assignee: TOYOTA JIDOSHA KABUSHIKI KAISHA, Toyota-shi (JP)

(21) Appl. No.: 17/675,483

(22) Filed: Feb. 18, 2022

(30) Foreign Application Priority Data
Feb. 24, 2021 (JP) 2021-027664

(51) Int. Cl. G06V 20/59; B60W 40/08

(52) U.S. Cl. CPC G06V 20/59; B60W 40/08; B60W 2540/227; B60W 2540/041

(57) ABSTRACT

An information processing device that includes a control unit that acquires an output of a sensor that detects a body of matter on each seat of a vehicle, and that transmits information on a permitted seat arrangement to a user terminal based on the output of the sensor.

### CROSS-REFERENCE TO RELATED APPLICATION

This application claims priority to Japanese Patent Application No. 2021-027664 filed on Feb. 24, 2021, incorporated herein by reference in its entirety.

### BACKGROUND

### 1. Technical Field

The present disclosure relates to an information processing device, an information processing method, and a system.

### 2. Description of Related Art

Known is a technology that enables a user to know an operation lever, etc. to be operated by light even when the user does not know a position of an operation lever, etc. by causing the operation lever, etc. to emit light in an order of operation for realizing a seat arrangement selected by the user on a touch panel, as in Japanese Unexamined Patent Application Publication No. 2010-143347 (JP 2010-143347 A).

### SUMMARY

An object of the present disclosure is to suppress a body of matter from coming into contact with a seat when performing seat arrangement of a vehicle by remote control.

An aspect of the present disclosure is an information processing device including a control unit that executes: acquiring an output of a sensor that detects a body of matter on each of seats of a vehicle; and transmitting information regarding a permitted seat arrangement to a user terminal based on the output of the sensor.

Another aspect of the present disclosure is an information processing method, in which the computer executes: acquiring an output of a sensor that detects a body of matter on each of seats of a vehicle; and transmitting information regarding a permitted seat arrangement to a user terminal based on the output of the sensor.

Another aspect of the present disclosure is a system including: a vehicle that includes a sensor that detects a body of matter on each of seats; and a server that transmits information regarding a permitted seat arrangement to a user terminal based on an output of the sensor.

Another aspect of the present disclosure provides a program for causing a computer to execute the above-described information processing method, or a storage medium that non-temporarily stores the program.

According to the present disclosure, it is possible to suppress a body of matter from coming into contact with a seat when performing seat arrangement of a vehicle by remote control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a block diagram schematically showing an example of respective configurations of a vehicle, a user terminal, and a center server configuring a system according to the embodiment;

FIG. 3 is a diagram showing an example of a functional configuration of the center server;

FIG. 4 is a diagram illustrating a functional configuration of the vehicle;

FIG. 5 is a diagram illustrating a functional configuration of the user terminal;

FIG. 6 is an example of an image displayed on a display according to a current seat state;

FIG. 7 is an example of an image for selecting whether to store or restore a seat;

FIG. 8 is an example of an image requesting input of a PIN code;

FIG. 9 is a diagram showing an example of an operation confirmation image;

FIG. 10 is a diagram showing an example of a completion image;

FIG. 11 is an example of an image displayed when an operation of the seat is stopped;

FIG. 12 is a sequence diagram showing the entire process of the system;

FIG. 13 is a flowchart of a process of the center server according to the embodiment;

FIG. 14 is a flowchart of a seat arrangement process executed in step S112 of FIG. 13;

FIG. 15 is a flowchart of a process of the vehicle according to the embodiment; and

FIG. 16 is a flowchart of a process of the user terminal according to the embodiment.

### DETAILED DESCRIPTION OF EMBODIMENTS

An information processing device that is one of the aspects of the present disclosure includes a control unit. The control unit acquires an output of a sensor that detects a body of matter on each seat of a vehicle, and transmits information on a permitted seat arrangement to a user terminal based on the output of the sensor.

The body of matter on the seat is, for example, a person or an object. The object is, for example, luggage of a user. The sensor may be, for example, a sensor that detects the pressure applied to the seat, or an image sensor that captures an image of a person or an object. Further, when a backrest of the seat is tilted forward or backward until it becomes horizontal, a body of matter on the backrest may be detected by the sensor. For example, it may be detected that luggage is placed on a stored seat. The sensor may detect a body of matter for each seat, or may detect a body of matter for each of a plurality of seats.

Here, when the seat arrangement is performed when there is a body of matter on the seat, the body of matter on the seat may come into contact with the seat or be sandwiched by the seat. Therefore, information regarding the seat arrangement to be permitted based on the output of the sensor is transmitted to the user terminal. The permitted seat arrangement is a seat arrangement that can suppress contact between the body of matter and the seat. By transmitting such information to the user terminal, the user can select a seat arrangement in a manner capable of suppressing contact between the body of matter and the seat. Therefore, it is possible to suppress the body of matter from coming into contact with the seat when performing seat arrangement of the vehicle by remote control.

The seat arrangement includes moving the position of one or more seats forward and backward or to the right and left, storing one or more seats under the floor or under another seat, restoring one or more seats from under the floor or under another seat, tilting the backrest of one or more seats in a forward direction or a backward direction, restoring the backrest of one or more seats from the tilted state, and changing the angle of a seating surface of one or more seats.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

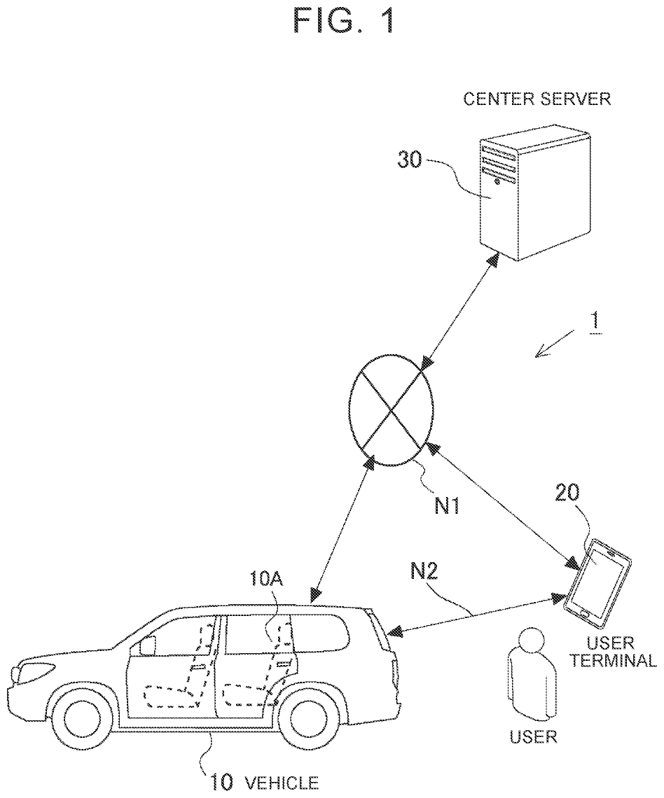

FIG. 1 is a diagram showing a schematic configuration of a system 1 according to a first embodiment. The system 1 is a system for performing seat arrangement of a vehicle 10 by remote control. The seat arrangement by remote control is executed, for example, when a predetermined condition is satisfied. The predetermined condition is a condition for knowing that the vehicle 10 is parked. For example, when it is detected that the driver stops a function of the vehicle 10 and leaves the vehicle 10, it is determined that the predetermined condition is satisfied. Here, even when a predetermined condition is satisfied, there may be a person in the vehicle. For example, even though there is a person in the vehicle, there is a case in which a user may forget that there is a person in the vehicle and thereby park and leave the vehicle 10. In such a case, when the seat arrangement is performed by remote control, the person left in the vehicle may come into contact with the moving seat.

A center server 30 generates information regarding the permitted seat arrangement so that the seat on which the body of matter is present does not move while the seat arrangement is being performed. Then, the information regarding the permitted seat arrangement is transmitted to a user terminal 20. With the user terminal 20, the user selects any one seat arrangement from the permitted seat arrangements, and transmits the seat arrangement selected by the user from the user terminal 20 to the center server 30. Then, the center server 30 generates a command for performing the seat arrangement received from the user terminal 20 and transmits the command to the vehicle 10. In the vehicle 10 that has received this command, the seat arrangement corresponding to the received command is performed. Further, when a person is detected in the vehicle while the seat arrangement is being performed, the center server 30 stops or restores a seat 10A.

In the example in FIG. 1, the system 1 includes the vehicle 10, the user terminal 20, and the center server 30. The user terminal 20 is a mobile terminal owned by the user. Further, the vehicle 10 is a vehicle associated with the user terminal 20. The vehicle 10, the user terminal 20, and the center server 30 are connected to each other by a network N1. The network N1 is, for example, a world-wide public communication network such as the Internet, and a wide area network (WAN) or other communication networks may be adopted. In addition, the network N1 may include a telephone communication network such as a mobile phone network and a wireless communication network such as Wi-Fi (registered trademark). Further, the vehicle 10 is connected to the user terminal 20 via a network N2 including short-range wireless communication and the like. Although FIG. 1 illustrates one vehicle 10 as an example, there may be a plurality of vehicles 10. Further, there may be a plurality of users and user terminals 20 depending on the number of vehicles 10.

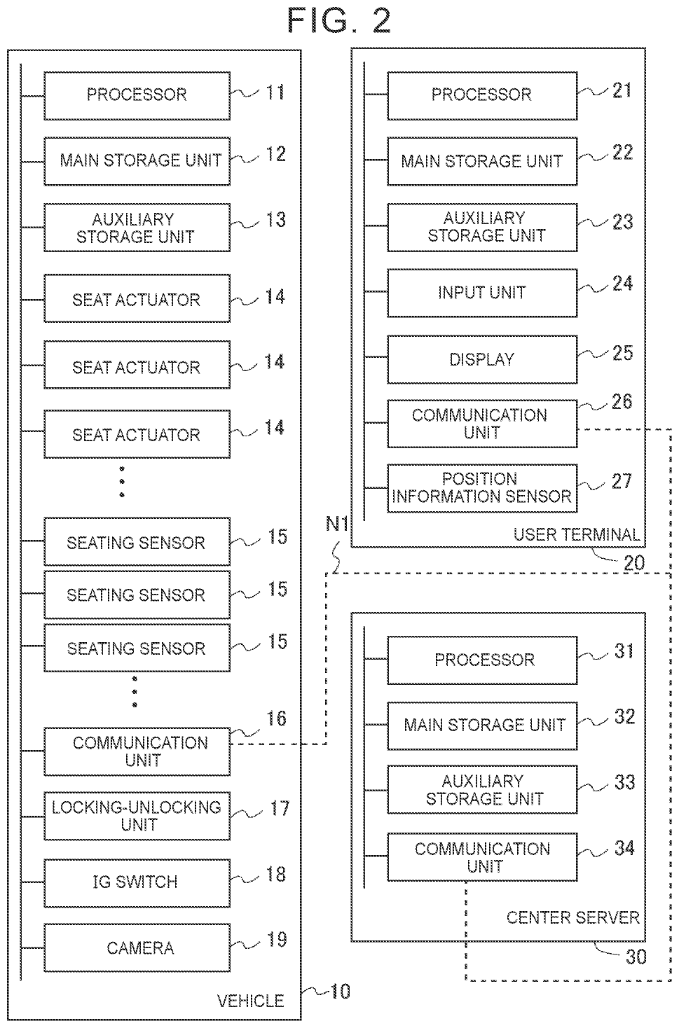

The hardware configurations of the vehicle 10, the user terminal 20, and the center server 30 will be described with reference to FIG. 2. FIG. 2 is a block diagram schematically showing an example of respective configurations of the vehicle 10, the user terminal 20, and the center server 30 configuring the system 1 according to the embodiment.

The center server 30 has a general computer configuration. The center server 30 includes a processor 31, a main storage unit 32, an auxiliary storage unit 33, and a communication unit 34. The components above are connected to each other by a bus.

The processor 31 is a central processing unit (CPU), a digital signal processor (DSP), or the like. The processor 31 controls the center server 30 and performs various information processing calculations. The main storage unit 32 is a random access memory (RAM), a read-only memory (ROM), or the like. The auxiliary storage unit 33 is an erasable programmable ROM (EPROM), a hard disk drive (HDD), a removable medium, or the like. The auxiliary storage unit 33 stores an operating system (OS), various kinds of programs, various kinds of tables, and the like. The processor 31 loads the program stored in the auxiliary storage unit 33 into the work area of the main storage unit 32 and executes the program. Through execution of the program, each component is controlled. As a result, the center server 30 realizes the function that matches the predetermined purpose. The main storage unit 32 and the auxiliary storage unit 33 are computer-readable recording media. The center server 30 may be a single computer or may include a plurality of computers linked together. Further, the information stored in the auxiliary storage unit 33 may be stored in the main storage unit 32. Further, the information stored in the main storage unit 32 may be stored in the auxiliary storage unit 33. The processor 31 is an example of a control unit according to the present disclosure. Further, the main storage unit 32 and the auxiliary storage unit 33 are examples of storage units according to the present disclosure.

The communication unit 34 is a means for communicating with the vehicle 10 and the user terminal 20 via the network N1. The communication unit 34 is, for example, a local area network (LAN) interface board or a wireless communication circuit for wireless communication. The LAN interface board and the wireless communication circuit are connected to the network N1.

The series of processes executed by the center server 30 can be executed by hardware or software.

Next, the user terminal 20 will be described. The user terminal 20 is a small computer such as a smartphone, a mobile phone, a tablet terminal, a personal information terminal, a wearable computer (smart watch, for example), or a personal computer (PC). The user terminal 20 includes a processor 21, a main storage unit 22, an auxiliary storage unit 23, an input unit 24, a display 25, a communication unit 26, and a position information sensor 27. The components above are connected to each other by a bus. The processor 21, the main storage unit 22, and the auxiliary storage unit 23 are similar to the processor 31, the main storage unit 32, and the auxiliary storage unit 33 of the center server 30, respectively, and thus the description thereof will be omitted.

The input unit 24 is a means for receiving an input operation performed by the user, and is, for example, a touch panel, a mouse, a keyboard, a push button, or the like. The display 25 is a means for presenting information to the user, for example, a liquid crystal display (LCD), an electroluminescence (EL) panel, or the like. The input unit 24 and the display 25 may be configured as one touch panel display.

The communication unit 26 is a communication means for connecting the user terminal 20 to the network N1 or the network N2. The communication unit 26 is a circuit for communicating with other devices (for example, the vehicle 10 or the center server 30) via the network N1 or the network N2 using wireless communication network such as a mobile communication service (for example, a telephone communication network such as the fifth generation (5G), the fourth generation (4G), the third generation (3G), and long term evolution (LTE)), Wi-Fi (registered trademark), Bluetooth (registered trademark), and the like.

The position information sensor 27 acquires the position information (for example, latitude and longitude) of the user terminal 20. The position information sensor 27 is, for example, a global positioning system (GPS) receiving unit, a wireless LAN communication unit, or the like.

Next, the vehicle 10 will be described. The vehicle 10 includes a processor 11, a main storage unit 12, an auxiliary storage unit 13, a seat actuator 14, a seating sensor 15, a communication unit 16, a locking-unlocking unit 17, an IG switch 18, and a camera 19. The components above are connected to each other by a bus. The processor 11, the main storage unit 12, the auxiliary storage unit 13, and the communication unit 16 are similar to the processor 21, the main storage unit 22, the auxiliary storage unit 23, and the communication unit 26 of the user terminal 20, and thus the description thereof will be omitted.

The seat actuator 14 is an actuator for moving the seat 10A, and is typically an electric motor. The seat actuator 14 is provided for each seat 10A. Further, a plurality of seat actuators 14 may be provided on one seat. The plurality of seat actuators 14 can be controlled independently from each other. Moving the seat 10A by the seat actuator 14 is also referred to as operating the seat 10A. Operating the seat 10A includes at least one of the following operations: moving the seat 10A forward and backward or to the right and left, storing the seat 10A under the floor or under another seat 10A, restoring the seat 10A from under the floor or under another seat 10A, tilting the backrest of the seat 10A in a forward direction or a backward direction, restoring the backrest of the seat 10A from the tilted state, and changing the angle of a seating surface of the seat 10A.

The seating sensor 15 is a sensor that detects that a body of matter is placed on the seat 10A. The seating sensor 15 may be, for example, a pressure sensor or a strain sensor in which a resistance value changes in accordance with the pressure. The seating sensor 15 is provided on the seating surface or the backrest of the seat 10A. Further, the seating sensor 15 is provided for each seat 10A.

The locking-unlocking unit 17 locks and unlocks a door of the vehicle 10. The IG switch 18 is a switch for starting the vehicle 10 or stopping the function of the vehicle 10 when pressed by the user. The camera 19 takes an image using an image sensor such as a charge coupled device (CCD) image sensor or a complementary metal oxide semiconductor (CMOS) image sensor. The image acquired by photographing or filming may be either a still image or a moving image. The camera 19 is provided in the vehicle cabin and is arranged so as to photograph or film the vehicle interior.

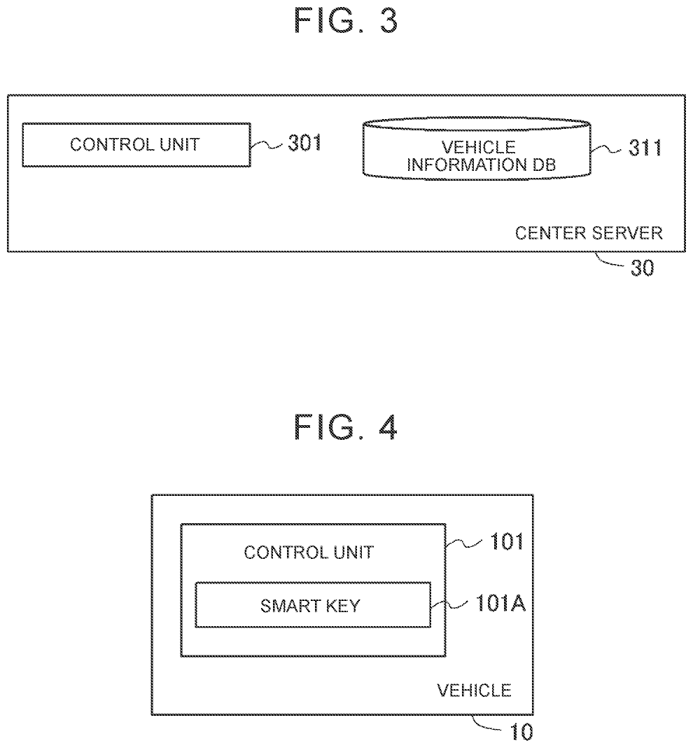

Next, the function of the center server 30 will be described. FIG. 3 is a diagram showing an example of a functional configuration of the center server 30. The center server 30 includes a control unit 301 and a vehicle information database (DB) 311 as functional components. The processor 31 of the center server 30 executes the process of the control unit 301 using a computer program stored in the main storage unit 32.

The vehicle information DB 311 is constructed in a manner such that a program of a database management system (DBMS) executed by the processor 31 manages data stored in the auxiliary storage unit 33. The vehicle information DB 311 is, for example, a relational database.

Note that a part of the process of the control unit 301 may be executed by another computer connected to the network N1.

The control unit 301 acquires information on the vehicle 10 (hereinafter, also referred to as vehicle information). The vehicle information is information for associating the vehicle 10 with the user terminal 20. The vehicle information stores a vehicle ID that is an identifier unique to the vehicle 10, a user ID that is an identifier unique to the user, and a user terminal ID that is an identifier unique to the user terminal 20. This information is registered in advance in the center server 30 by the user by using the user terminal 20. Further, the vehicle information includes information on the arrangement of the seats 10A of the vehicle 10 and information on how each seat 10A operates. In addition, the vehicle information may include information regarding selectable seat arrangements. When the control unit 301 acquires the vehicle information, it stores the vehicle information in the vehicle information DB 311.

The control unit 301 remotely controls the seat arrangement of the vehicle 10 when predetermined conditions are satisfied. The predetermined conditions are, for example, that the vehicle 10 is in a state in which the function of the vehicle 10 is stopped (a state in which the vehicle 10 is shut down), and that the user is away from the vehicle 10. In such a state, it can be said that the vehicle 10 is in a parked state. The control unit 301 uses the function of a smart key 101A described later to determine whether an electronic key 201A described later is present in the vehicle. When the electronic key 201A is not present in the vehicle, it is considered that the user has gone out the vehicle 10 with the electronic key 201A. Further, the control unit 301 acquires the activation state of the vehicle 10. That is, it is acquired whether the user has pressed the IG switch 18 to shut down the vehicle 10. When the vehicle 10 is parked, it is considered that the user will not immediately drive the vehicle 10.

The control unit 301 determines whether a predetermined condition is satisfied based on the detection state of the electronic key 201A and the activation state of the vehicle 10 that are transmitted from the vehicle 10. That is, when the electronic key 201A is detected by the vehicle 10 and the function of the vehicle 10 is stopped (shut down state), it is determined that the predetermined condition is satisfied. The detection state of the electronic key 201A and the activation state of the vehicle 10 may be transmitted from the vehicle 10 at predetermined intervals, or may be transmitted when the detection state of the electronic key 201A or the activation state of the vehicle 10 changes.

In the present embodiment, whether the predetermined condition is satisfied is determined based on the detection state of the electronic key 201A and the activation state of the vehicle 10. However, the predetermined condition is not limited to this. For example, instead of the detection state of the electronic key 201A, a door lock state may be a condition. That is, when the door is locked from the outside of the vehicle and the vehicle 10 is shut down, it may be determined that the predetermined condition is satisfied. Further, for example, when the vehicle 10 is shut down and the door is opened and closed once, it is considered that the driver has gotten off the vehicle and thus, it may be determined that the predetermined condition is satisfied.

Further, the control unit 301 acquires the seat state at the current time from the vehicle 10 in response to a request from the user terminal 20. The seat state at the current time is information indicating how the seat 10A is arranged at the current time. The control unit 301 receives a request for confirming the current state of the seat 10A (hereinafter, also referred to as a current state confirmation request) from the user terminal 20. Upon receiving the current state confirmation request, the control unit 301 transmits a command to the vehicle 10 to transmit information on the seat state at the current time, the output of the seating sensor 15, and the output of the camera 19.

The control unit 301 receives information on the current seat state, the output of the seating sensor 15, and the output of the camera 19 from the vehicle 10 that responds to this command. Based on at least one of the output of the seating sensor 15 and the output of the cameras 19, it is determined whether a body of matter (including a person or a body of matter) is placed on each seat 10A. For example, when the output of the seating sensor 15 is equal to the output when a person is sitting on the seat 10A, it can be determined that a person is sitting on the seat 10A. Further, for example, it may be determined whether a body of matter is placed on each seat 10A by performing an image process on the image data captured by the camera 19.

For example, the control unit 301 determines whether each seat 10A can be moved by assuming that the seat 10A on which the body of matter is not placed is the movable seat 10A and the seat 10A on which the body of matter is placed is the non-movable seat 10A. Then, the determination result is transmitted to the user terminal 20 together with the information regarding the current state of the seat. At this time, the control unit 301 displays, for example, the current seat state on the display 25 of the user terminal 20, and further transmits information to the user terminal 20 so that the movable seat 10A can be selected. As an alternative method, when it is determined that a body of matter is placed on any of the seats 10A, the operation of all the seats 10A may be prohibited. By doing so, it is possible to more reliably suppress the body of matter from coming into contact with the seat 10A.

Further, a relationship between the seat 10A on which the body of matter is present and the permitted seat arrangement may be stored in advance in the auxiliary storage unit 33. For example, when a body of matter is present on any of the seats 10A, it may be stored that there is no seat arrangement that can be permitted. Alternatively, for example, it may be stored in the auxiliary storage unit 33 to prohibit the operation of the seat 10A on which the body of matter is present. Alternatively, for example, it may be stored in the auxiliary storage unit 33 to prohibit the operation of the seat 10A on which the body of matter is present and the seat 10A next to the seat 10A on which the body of matter is present.

In addition, the control unit 301 receives a request to perform seat arrangement from the user terminal 20. The request for performing this seat arrangement includes information regarding the seat 10A to be moved, information regarding the moving direction when the seat 10A is moved, and the like. At this time, the control unit 301 may request the user terminal 20 to input a password or a PIN code in order to confirm whether the request is from a legitimate user.

Upon receiving the request for performing the seat arrangement, the control unit 301 generates a command for performing the seat arrangement and transmits it to the vehicle 10. The command for performing the seat arrangement is generated based on the request for performing the seat arrangement received from the user terminal 20. When the seat arrangement is completed in the vehicle 10, a completion report is transmitted from the vehicle 10. When the control unit 301 receives the completion report from the vehicle 10, it generates a command for displaying that the seat arrangement has been completed on the display 25 of the user terminal 20 and transmits the command to the user terminal 20.

Further, the control unit 301 receives the output of the camera 19 from the vehicle 10 after transmitting the command for performing the seat arrangement to the vehicle 10. Then, the control unit 301 determines whether a body of matter is present on the seat 10A based on the output of the camera 19. At this time, it may be determined whether there is a person in the vehicle. Then, when it is determined that a body of matter is present on the seat 10A, a command for stopping the seat arrangement is generated and transmitted to the vehicle 10. In addition, information regarding stopping the seat arrangement is generated and transmitted to the user terminal 20. This information may include information to inform the user that a person is present in the vehicle. Further, instead of the camera 19, or together with the camera 19, it may be determined whether a body of matter is present on the seat 10A based on the output of the seating sensor 15. In this way, when a body of matter is found during the operation of the seat, the operation of the seat is immediately stopped. Thereby, the safety performance can be further improved.

Next, the function of the vehicle 10 will be described. FIG. 4 is a diagram illustrating the functional configuration of the vehicle 10. The vehicle 10 includes a control unit 101 as a functional component. The processor 11 of the vehicle 10 executes the process of the control unit 101 using a computer program stored in the main storage unit 12. However, a part of the control unit 101 process may be executed by a hardware circuit.

The control unit 101 has a function of the smart key 101A that locks and unlocks the door by operating the locking-unlocking unit 17 based on a signal from the user terminal 20. The control unit 101 uses the function of the smart key 101A to perform short-range wireless communication with the electronic key 201A described later. Then, for example, information on whether the smart key 101A can communicate with the electronic key 201A, or information on the strength of the radio wave from the electronic key 201A is transmitted to the center server 30 as the detection state of the electronic key 201A.

Further, the control unit 101 transmits the detection value of the seating sensor 15, the detection state of the electronic key 201A, the detection value of the camera 19, the activation state of the vehicle 10, and the state of the seat 10A to the center server 30 at predetermined intervals. Note that the transmission of the above information may be limited to when the state has changed. Further, the transmission of the above information may be performed in response to a request from the center server 30.

The detection value of the seating sensor 15 is information related to whether a body of matter is present on the seat 10A. The detection state of the electronic key 201A indicates the communication state between the smart key 101A and the electronic key 201A, and is information capable of determining whether the user having the electronic key 201A is present in the vehicle. The detection value of the camera 19 is information capable of determining whether a person or an object is present in the vehicle. The activation state of the vehicle 10 is information capable of determining whether the vehicle 10 is activated or has stopped functioning. The activation state of the vehicle 10 changes, for example, when the user presses the IG switch 18.

The state of the seat 10A may be, for example, information indicating whether the backrest is in the stored state or the restored state. The stored state refers to a state in which the backrest is tilted toward the front of the vehicle until it hits the seating surface. By putting the backrest in the stored state, the luggage space can be expanded. Further, in the case of a three-row seat, by putting the second-row seat 10A in the stored state, access to the third-row seat 10A becomes easy. The restored state is a state in which the backrest is raised, and a state in which a person can sit on the seat 10A. As for the state of the seat 10A, for example, the operation history of the seat actuator 14 in the past may be stored in the auxiliary storage unit 13, and the state of the seat 10A may be acquired based on the operation history. Alternatively, a sensor may be attached to a movable portion of the seat 10A, and the state of the seat 10A may be detected based on the detection value of the sensor.

When the control unit 301 receives a command from the center server 30 via the communication unit 16, the control unit 301 executes a process in accordance with the command. When the control unit 101 receives a command to perform the seat arrangement from the center server 30, the control unit 101 operates the seat actuator 14 to change the state of the seat 10A.

Further, the control unit 101 transmits the detection value of the camera 19 to the center server 30 when the seat actuator 14 is operated based on the command from the center server 30. The detection value of the camera 19 may be transmitted to the center server 30 at predetermined time intervals, or may be transmitted to the center server 30 when the detection value changes. When a command to stop the movement of the seat 10A is received from the center server 30 after the detection value of the camera 19 is transmitted to the center server 30, the control unit 101 stops the seat actuator 14. When the seat actuator 14 is stopped, the control unit 101 may notify the center server 30 that the seat actuator 14 has been stopped.

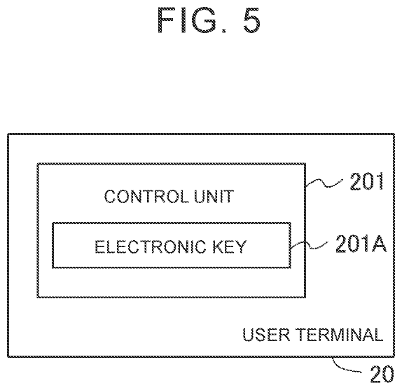

Next, functions of the user terminal 20 will be described. FIG. 5 is a diagram illustrating a functional configuration of the user terminal 20. The user terminal 20 includes a control unit 201 as a functional component. The processor 21 of the user terminal 20 executes the process of the control unit 201 using a computer program stored in the main storage unit 22. However, a part of the control unit 201 process may be executed by a hardware circuit. The control unit 201 has the function of the electronic key 201A of the smart key system. As an alternative method, the user may have a terminal having an electronic key function in addition to the user terminal 20. The control unit 201 (electronic key 201A) establishes communication with the smart key 101A of the vehicle 10 to lock and unlock the vehicle 10.

Further, the control unit 201 transmits a current state confirmation request to the center server 30. For example, when the input unit 24 receives an input to start an application software for performing the seat arrangement (for example, when an icon of the application software displayed on the display 25 is tapped), the control unit 201 transmits a current state confirmation request that is a request for confirming the state of the seat 10A to the center server 30.

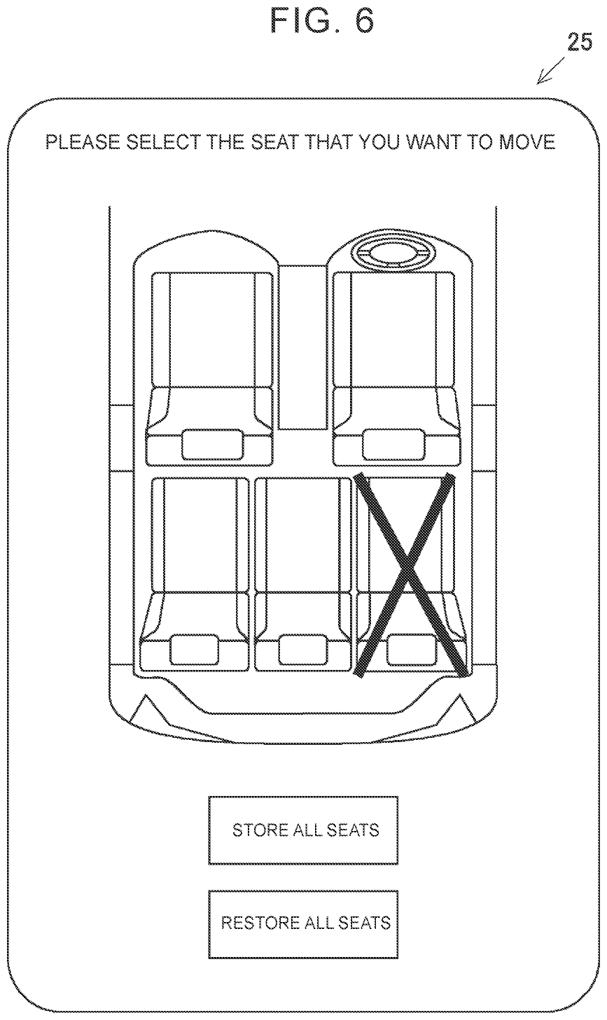

When the control unit 201 receives the information regarding the current seat state from the center server 30, the control unit 201 displays an image corresponding to the current seat state on the display 25. FIG. 6 is an example of an image displayed on the display 25 in accordance with the current seat state. Here, a display in which it is possible to recognize whether each seat 10A is in the stored state or the restored state is performed. In addition, a display is carried out so that the movable seat 10A and the immovable seat 10A can be recognized. For example, the immovable seat 10A may be marked to that effect, such as marked with a cross, or grayed out. In the example shown in FIG. 6, the seat 10A at the right end of the back row is marked with a cross. This indicates that a body of matter is present on the seat 10A and cannot be selected.

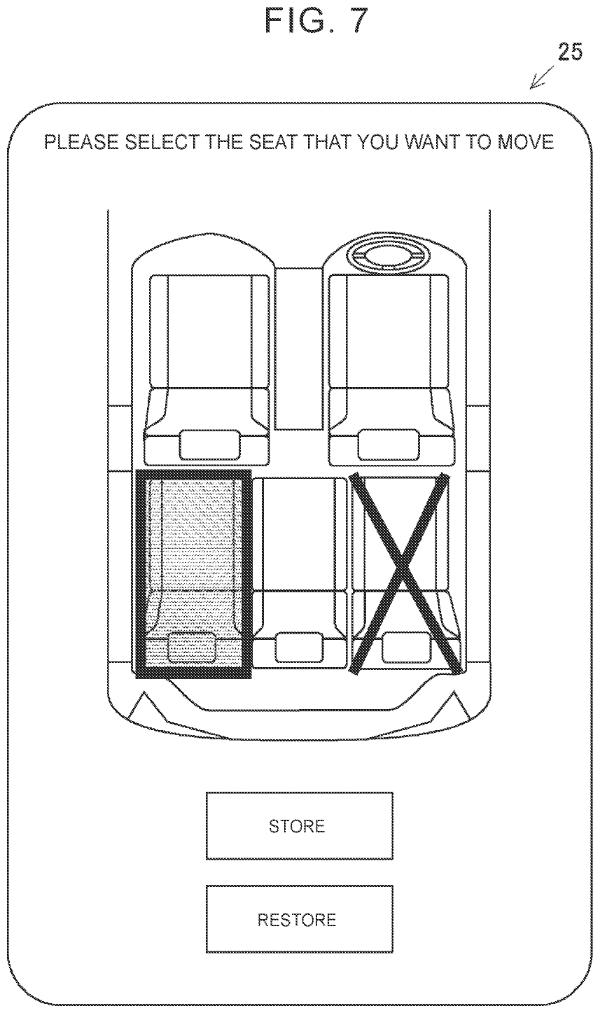

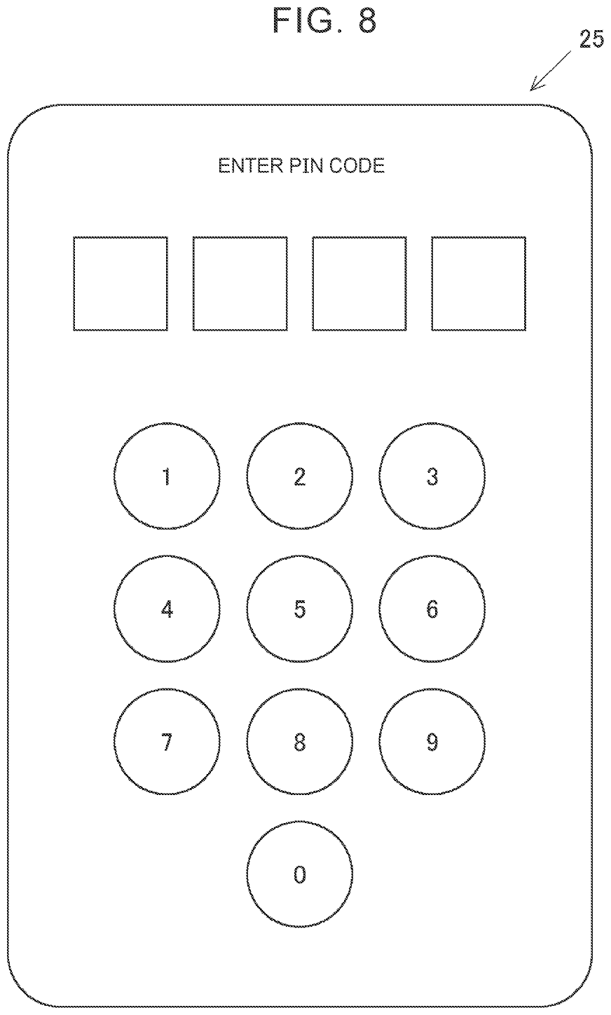

When the user selects (taps) the seat 10A displayed on the display 25, the control unit 201 switches to an image for selecting whether to store the seat 10A or restore the seat 10A. FIG. 7 is an example of an image for selecting whether to store or restore the seat 10A. The example shown in FIG. 7 shows a case where the user has tapped the leftmost seat 10A in the back row, and the portion of the seat 10A is colored so that the tapped seat 10A can be seen. Buttons displayed with the words “store” and “restore” are buttons for selecting whether to store or restore the seat 10A. When the user taps the “store” or “restore” button, the control unit 201 causes the display 25 to display, for example, an image asking for a PIN code.

FIG. 8 is an example of an image for requesting the input of the PIN code. The user inputs the PIN code by tapping the button showing the number corresponding to the PIN code. When the user inputs the PIN code, the control unit 201 transmits the PIN code to the center server 30. When the PIN code is authenticated by the center server 30, information regarding the PIN code authentication is received from the center server 30. As an alternative method, the control unit 201 may perform authentication. In this case, the information required for authentication is received from the center server 30 in advance.

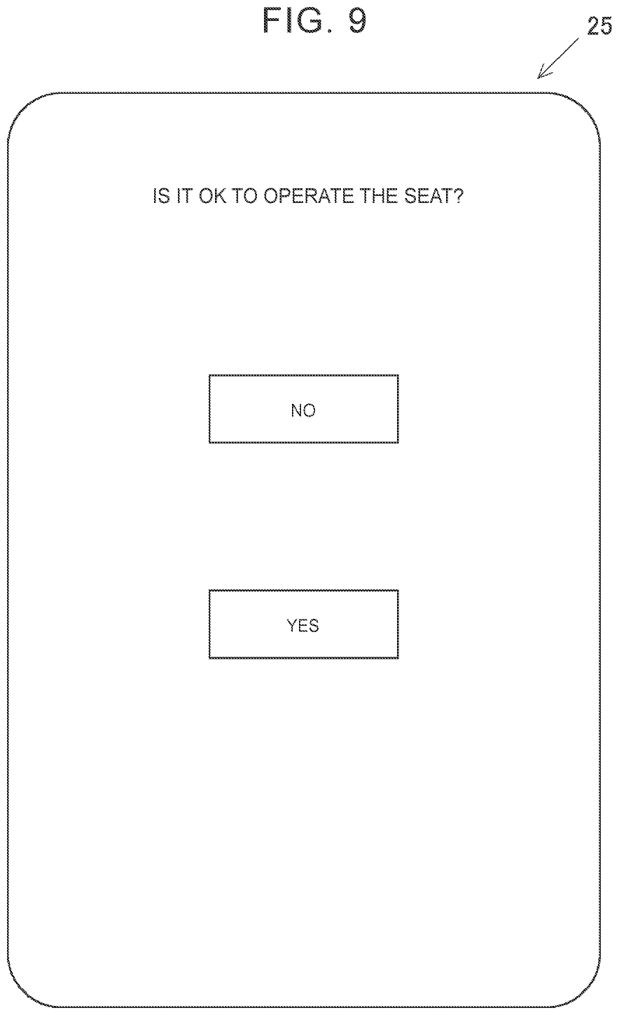

Upon receiving the information regarding the PIN code authentication, the control unit 201 causes the display 25 to display an operation confirmation image. FIG. 9 is a diagram showing an example of the operation confirmation image. This image is displayed to confirm with the user as to whether the seat arrangement may be performed. For example, “YES” and “NO” buttons are displayed with the words “Is it OK to activate the seat?” When the user taps the “YES” button, the control unit 201 transmits information regarding the request for performing the seat arrangement to the center server 30. When the user presses the “NO” button, the control unit 201 displays the image shown in FIG. 6 or FIG. 7.

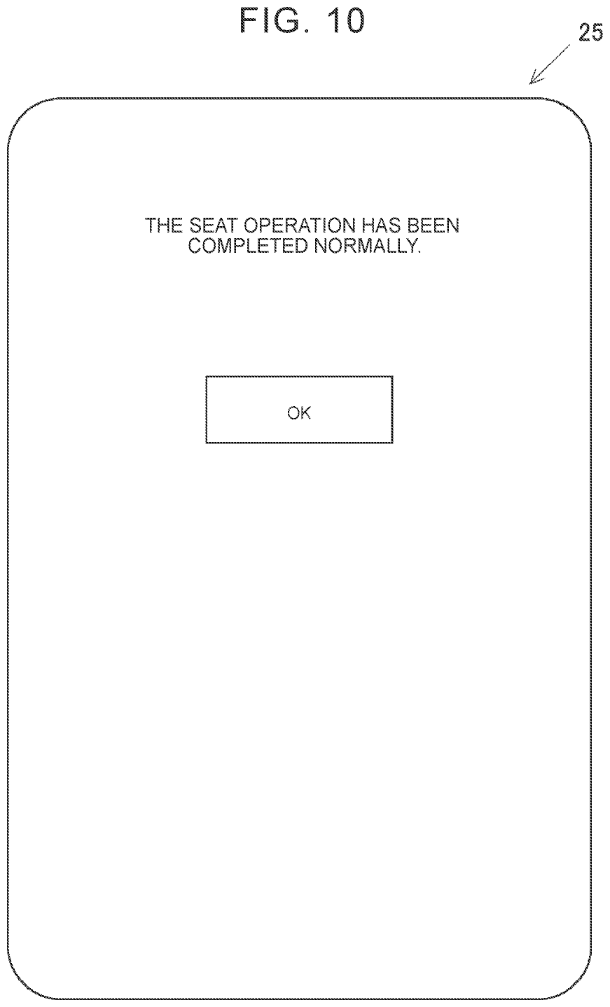

Further, when the seat arrangement is completed in the vehicle 10, the completion report is transmitted from the center server 30 to the user terminal 20. Upon receiving this completion report, the control unit 201 causes the display 25 to display a completion image. FIG. 10 is a diagram showing an example of the completion image. For example, an “OK” button is displayed with the words “The seat operation has been completed normally.” When the user taps the “OK” button, the control unit 201 causes the display 25 to display an image showing the current seat state.

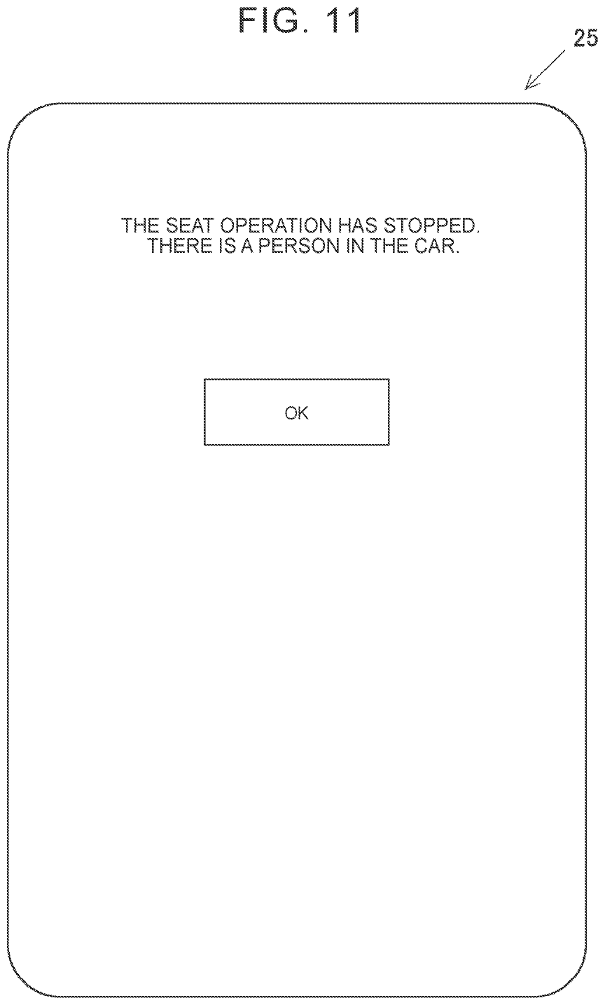

In contrast, when the operation of the seat is stopped while the seat arrangement is being performed, the user is notified that the operation of the seat has been stopped. FIG. 11 is an example of an image displayed when the operation of the seat has been stopped. For example, an “OK” button is displayed with the words “The seat operation has been stopped.” When the user taps the “OK” button, the control unit 201 displays, for example, the image of FIG. 6 or FIG. 7. When the operation of the seat 10A is stopped, the reason may be indicated therewith. The reason why the operation of the seat 10A has been stopped is transmitted from the center server 30. For example, words such as “There is a person in the car.” may be displayed.

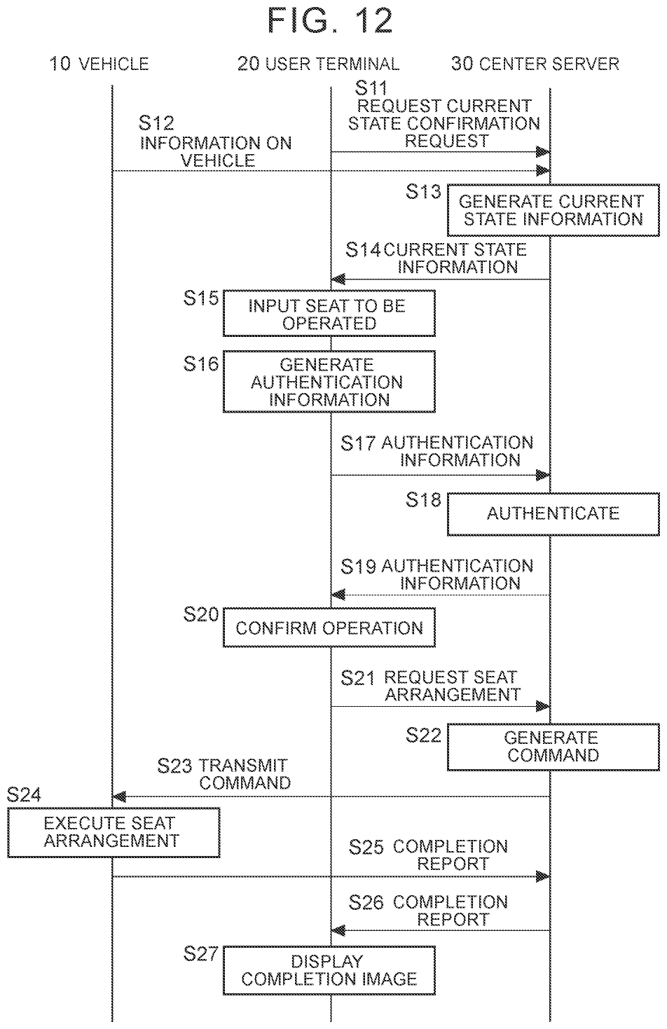

Next, overall processes of the system 1 will be described. FIG. 12 is a sequence diagram showing the entire process of the system 1. The vehicle 10 and the user terminal 20 shown in FIG. 12 are associated with each other in advance and registered in the center server 30. When the user activates the predetermined application software on the user terminal 20, a current state confirmation request is transmitted from the user terminal 20 to the center server 30 (S11). Further, information on the vehicle 10 is transmitted from the vehicle 10 to the center server 30 at predetermined time intervals (S12). The information regarding the vehicle 10 referred to here includes information regarding the current seat state, the output of the seating sensor 15, the output of the camera 19, the detection state of the electronic key 201A, the activation state of the vehicle 10, and the like. In FIG. 12, information regarding the vehicle 10 is transmitted from the vehicle 10 to the center server 30 at predetermined time intervals. However, as an alternative method, in response to a request from the center server 30 that has received the current state confirmation request from the user terminal 20, the vehicle 10 may transmit information regarding the vehicle 10 to the center server 30.

The center server 30 generates the current state information based on the information on the vehicle 10 (S13) and transmits it to the user terminal 20 (S14). The current state information includes information on the current seat state and information on the operable seat 10A and the inoperable seat 10A. When the user inputs the seat 10A to be operated in the user terminal 20 (S15), the user terminal 20 asks the user to input the PIN code. When the PIN code is input, the authentication information is generated (S16), and the authentication information is transmitted to the center server 30 (S17). The center server 30 that has received the authentication information performs authentication by collating the PIN code (S18). When the user authentication is completed, the information regarding the completion of the authentication is transmitted from the center server 30 to the user terminal 20 (S19).

On the user terminal 20, an image for confirming with the user whether the seat 10A may be operated is displayed (S20), and when the user performs an input indicating that the seat 10A may be operated, a request for performing the seat arrangement is transmitted from the user terminal 20 to the center server 30 (S21). This request includes information on the seat 10A to be moved. Upon receiving this request, the center server 30 generates a command for performing the seat arrangement (S22) and transmits it to the vehicle 10 (S23).

In the vehicle 10 that has received the command, the seat arrangement is performed (S24). In the vehicle 10, the seat arrangement is performed by operating the seat actuator 14. When the seat arrangement is completed, the completion report is transmitted from the vehicle 10 to the center server 30 (S25). The completion report is transferred from the center server 30 to the user terminal 20 (S26). The user terminal 20 that has received the completion report causes the display 25 to display an image indicating that the seat arrangement is completed (S27).

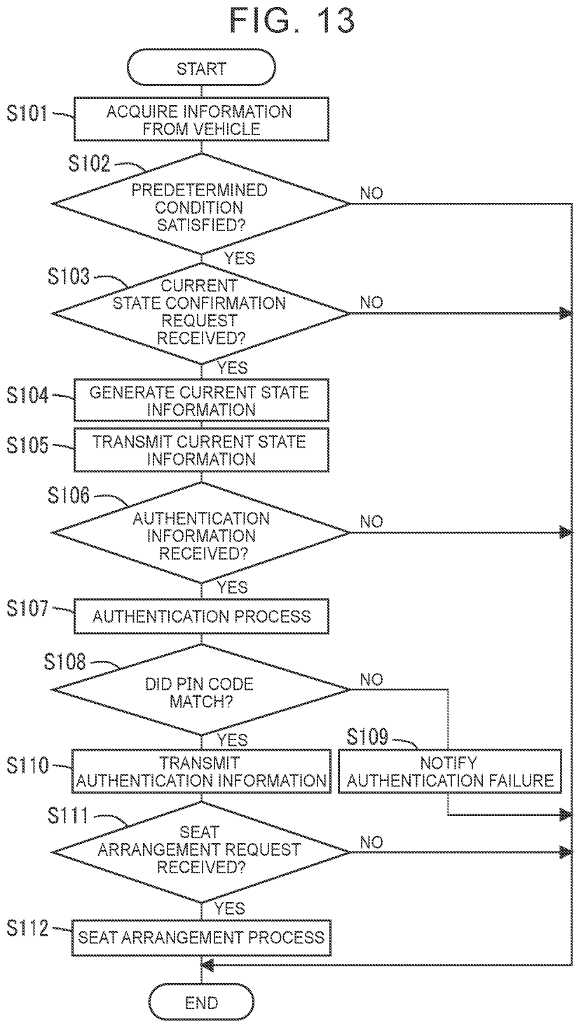

Next, the process in the center server 30 will be described. FIG. 13 is a flowchart of a process of the center server 30 according to the embodiment. The process shown in FIG. 13 is repeatedly executed in the center server 30 at predetermined time intervals for each vehicle 10. In addition, it is assumed that necessary information is stored in the vehicle information DB 311.

In step S101, the control unit 301 acquires information from the vehicle 10. The information acquired at this time includes the information on a predetermined condition, information on a current seat state, an output of the seating sensor 15, and an output of the camera 19.

In step S102, the control unit 301 determines whether a predetermined condition is satisfied. For example, the control unit 301 determines whether the vehicle 10 has been shut down and whether communication between the electronic key 201A and the smart key 101A has not been established. When an affirmative determination is made in step S102, the process proceeds to step S103, and when a negative determination is made, the routine is terminated.

In step S103, the control unit 301 determines whether the current state confirmation request has been received from the user terminal 20. When an affirmative determination is made in step S103, the process proceeds to step S104, and when a negative determination is made, the routine is terminated.

In step S104, the control unit 301 generates the current state information. The current state information includes information on the current seat state and information on the operable seat 10A and the inoperable seat 10A. Then, in step S105, the control unit 301 transmits the current state information to the user terminal 20.

In step S106, the control unit 301 determines whether the authentication information has been received from the user terminal 20. When an affirmative determination is made in step S106, the process proceeds to step S107, and when a negative determination is made, the routine is terminated. The control unit 301 may make a negative determination when the authentication information is not received from the user terminal 20 for a predetermined time.

In step S107, the control unit 301 executes the authentication process. The control unit 301 compares the PIN code input by the user to the user terminal 20 with the PIN code registered in advance in the auxiliary storage unit 33. Then, in step S108, the control unit 301 determines whether the PIN codes match. When an affirmative determination is made in step S108, the process proceeds to step S110, and when a negative determination is made, the process proceeds to step S109.

In step S109, the control unit 301 notifies the user terminal 20 that the authentication has failed. This notification may include information for displaying on the display 25 of the user terminal 20 that the authentication has failed. In contrast, in step S110, the control unit 301 transmits the authentication information indicating that the authentication is successful to the user terminal 20.

In step S111, the control unit 301 determines whether the seat arrangement request has been received from the user terminal 20. When the seat arrangement request is not received from the user terminal 20 even after waiting for a predetermined time, a negative determination is made. When an affirmative determination is made in step S111, the process proceeds to step S112 to execute the seat arrangement process. The seat arrangement process will be described later. In contrast, when a negative determination is made in step S111, this routine is terminated.

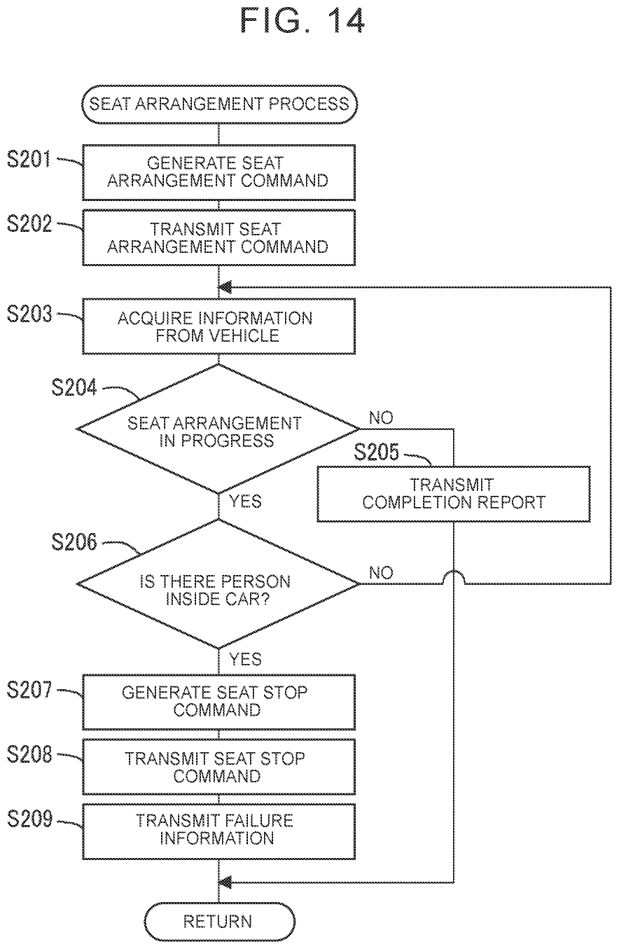

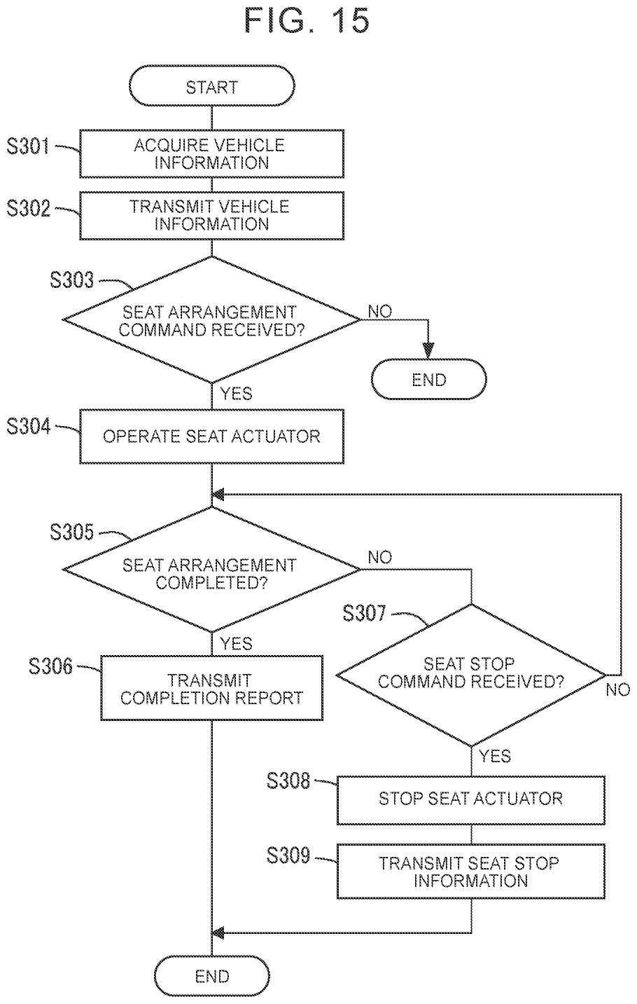

FIG. 14 is a flowchart of the seat arrangement process executed in step S112 of FIG. 13. In step S201, the control unit 301 generates a seat arrangement command. The seat arrangement command is a command to carry out the seat arrangement and includes information on the operating seat 10A. In step S202, the control unit 301 transmits a seat arrangement command to the vehicle 10.

In step S203, the control unit 301 acquires information from the vehicle 10. The information acquired here includes information on the seat state at the current time, information indicating that the seat arrangement is completed (completion report), the detection value of the seating sensor 15, and the detection value of the camera 19. In step S204, the control unit 301 determines whether the seat arrangement is being carried out in the vehicle 10. For example, when the completion report has not been received, it is determined that the seat arrangement is in progress. Alternatively, the control unit 301 may determine that the seat arrangement is in progress when the seat state at the current time is not the state corresponding to the command transmitted in step S202. When an affirmative determination is made in step S204, the process proceeds to step S206, and when a negative determination is made, the process proceeds to step S205.

In step S205, the control unit 301 transmits a completion report to the user terminal 20. This completion report is transmitted to display the completion image on the display 25 of the user terminal 20. The completion image is the image shown in FIG. 10, and is an image showing that the seat arrangement is completed.

In step S206, the control unit 301 determines whether a person is present in the vehicle. The control unit 301 determines whether a person is present in the vehicle by analyzing the image data captured by the camera 19. When an affirmative determination is made in step S206, the process proceeds to step S207, and when a negative determination is made, the process returns to step S203.

In step S207, the control unit 301 generates a seat stop command. The seat stop command is a command for stopping the operation of the seat 10A of the vehicle 10. When there is a person in the vehicle, contact between the seat 10A and the person is suppressed by stopping the operation of the seat 10A. In step S208, the control unit 301 transmits a seat stop command to the vehicle 10.

Further, in step S209, the control unit 301 transmits failure information to the user terminal 20. The failure information is information for notifying that the seat arrangement has failed. The failure information includes a command for displaying the seat arrangement failure image on the display 25. The seat arrangement failure image is the image shown in FIG. 11, and is an image showing that the seat arrangement has failed. By transmitting this command, the user terminal 20 is notified that the seat arrangement has failed. After that, this routine is terminated. As a result, the routine shown in FIG. 13 is also terminated.

Next, a process in the vehicle 10 will be described. FIG. 15 is a flowchart of a process of the vehicle 10 according to the present embodiment. The process shown in FIG. 15 is repeatedly executed in the vehicle 10 at predetermined time intervals.

In step S301, the control unit 101 acquires information on the vehicle 10. The information acquired here is information corresponding to the information received by the center server 30 in step S101 of FIG. 13. That is, the control unit 101 acquires the detection state of the electronic key 201A, the activation state of the vehicle 10, the information on the current seat state, the output of the seating sensor 15, and the output of the camera 19.

In step S302, the control unit 101 transmits the acquired information on the vehicle 10 to the center server 30. In step S303, the control unit 101 determines whether the seat arrangement command has been received from the center server 30. This seat arrangement command is transmitted from the center server 30 in step S202 of FIG. 14. When an affirmative determination is made in step S303, the process proceeds to step S304, and when a negative determination is made, the routine is terminated.

In step S304, the control unit 101 starts the operation of the seat actuator 14 so as to operate the seat 10A. At this time, the seat actuator 14 corresponding to the seat 10A whose movement is instructed by the seat arrangement command is operated.

In step S305, the control unit 101 determines whether the seat arrangement is completed. That is, the control unit 101 determines whether the seat state included in the seat arrangement command is equal to the seat state at the current time. For example, when the seat 10A is provided with a sensor for detecting the seat state, the seat state is detected based on the detection value of the sensor. Alternatively, by detecting the current passing through the seat actuator 14, it can be determined whether the operation of the seat 10A is completed. Further, as another method, it may be determined that the seat arrangement is completed when a predetermined time has elapsed from the start of operation of the seat actuator 14. When an affirmative determination is made in step S305, the process proceeds to step S306, and when a negative determination is made, the process proceeds to step S307.

In step S306, the control unit 101 transmits a completion report to the center server 30. The completion report is information indicating that the seat arrangement has been completed. The completion report is received by the center server 30 in step S203 of FIG. 14. In contrast, in step S307, the control unit 101 determines whether the seat stop command has been received from the center server 30. The seat stop command is transmitted from the center server 30 in step S208 of FIG. 14. When an affirmative determination is made in step S307, the process proceeds to step S308, and when a negative determination is made, the process returns to step S305.

In step S308, the control unit 101 stops the seat actuator 14. Then, in step S309, the control unit 101 transmits the seat stop information to the center server 30. The seat stop information is information indicating that the operation of the seat 10A has been stopped. The process of step S309 can be omitted.

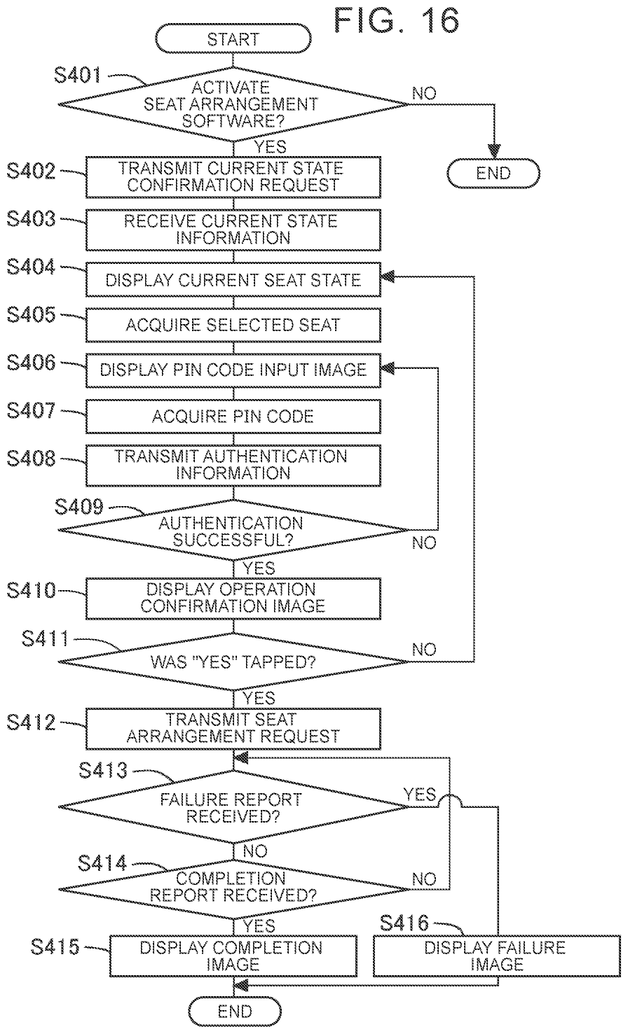

Next, functions of the user terminal 20 will be described. FIG. 16 is a flowchart of a process of the user terminal 20 according to the present embodiment. The process shown in FIG. 16 is repeatedly executed in the user terminal 20 at predetermined time intervals.

In step S401, the control unit 201 determines whether the application software for requesting the seat arrangement has been started by the user. When the user taps a predetermined icon displayed on the display 25, the application software for requesting the seat arrangement is started. When an affirmative determination is made in step S401, the process proceeds to step S402, and when a negative determination is made, the routine is terminated.

In step S402, the control unit 201 transmits the current state confirmation request to the center server 30. The identification information of the user terminal 20 is associated with this request. In step S403, the control unit 201 receives the current state information from the center server 30. At this time, the current state information transmitted from the center server 30 in step S105 of FIG. 13 is received. In step S404, the control unit 201 causes the display 25 to display an image in accordance with the current seat state. Here, the image shown in FIG. 6 is displayed.

In step S405, the control unit 201 acquires information on the seat 10A selected by the user. When the user selects the seat 10A, the image shown in FIG. 7 is displayed. At this time, the control unit 201 also acquires whether “store” or “restore” is selected for the selected seat. In step S406, the control unit 201 causes the display 25 to display an image asking the user to input the PIN code. At this time, the image shown in FIG. 8 is displayed. Then, in step S407, the control unit 201 acquires the PIN code input by the user.

In step S408, the control unit 201 transmits the authentication information including the PIN code to the center server 30. The authentication information is associated with the identification information of the user terminal 20. The authentication information is received by the center server 30 in step S106 of FIG. 13. In step S409, the control unit 201 determines whether the authentication is successful. When the authentication information is transmitted from the center server 30 in step S110 of FIG. 13, an affirmative determination is made in step S409. In contrast, when the information regarding the failure of the authentication is transmitted from the center server 30 in step S109 of FIG. 13, a negative determination is made in this step S409. When an affirmative determination is made in step S409, the process proceeds to step S410, and when a negative determination is made, the process returns to step S406. The control unit 201 may display on the display 25 that the authentication has failed before returning to step S406.

In step S410, the control unit 201 causes the display 25 to display the operation confirmation image. At this time, the control unit 201 causes the display 25 to display the image shown in FIG. 9. In step S411, the control unit 201 determines whether the user has tapped the “YES” button. When an affirmative determination is made in step S411, the process proceeds to step S412, and when a negative determination is made, the process returns to step S404.

In step S412, the control unit 201 transmits a seat arrangement request to the center server 30. The seat arrangement request transmitted at this time is received by the center server 30 in step S111 of FIG. 13. In step S413, the control unit 201 determines whether the failure information has been received from the center server 30. The failure information is information transmitted from the center server 30 in step S209 of FIG. 14. When an affirmative determination is made in step S413, the process proceeds to step S416, and when a negative determination is made, the process proceeds to step S414. In step S416, the control unit 201 causes the display 25 to display the seat arrangement failure image. The seat arrangement failure image is the image shown in FIG. 11.

In step S414, the control unit 201 determines whether the completion report has been received from the center server 30. This completion report is information transmitted from the center server 30 in step S205 of FIG. 14. When an affirmative determination is made in step S414, the process proceeds to step S415, and when a negative determination is made, the process returns to step S413. In step S415, the control unit 201 displays the completion image on the display 25. The completion image is the image shown in FIG. 10.

As described above, according to the present embodiment, when the seat arrangement of the vehicle 10 is performed by remote control, the seat 10A on which a body of matter is placed is not activated and thus, it is possible to suppress the moving seat 10A and a person or an object from coming into contact with the body of matter and suppress the body of matter from being sandwiched by the seat 10A. Further, when a body of matter is detected on the seat 10A while the seat arrangement is being performed, the operation of the seat 10A can be stopped and thus, it is possible to suppress a person or an object from coming into contact with the operating seat 10A.

### OTHER EMBODIMENTS

The above-described embodiments are merely examples, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function. For example, the vehicle 10 may have a part or all of the functions of the center server 30.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit that executes:
acquiring an output of a sensor that detects a body of matter on each of seats of a vehicle; and
transmitting information regarding a permitted seat arrangement to a user terminal based on the output of the sensor.

2. The information processing device according to claim 1, further comprising a storage unit that stores a relationship between the output of the sensor and the permitted seat arrangement.

3. The information processing device according to claim 1, wherein the control unit sets a seat on which the body of matter is not detected as a seat that is able to be operated and sets a seat on which the body of matter is detected as a seat that is not able to be operated, and generates the information regarding the permitted seat arrangement.

4. The information processing device according to claim 1, wherein when the body of matter is detected on any of the seats, the control unit sets all the seats as seats that are not able to be operated, and generates the information regarding the permitted seat arrangement.

5. The information processing device according to claim 1, wherein when the control unit transmits the information regarding the permitted seat arrangement to the user terminal and then receives information regarding a request for seat arrangement from the user terminal, the control unit transmits a command to the vehicle to perform the seat arrangement in accordance with the request.

6. The information processing device according to claim 1,
wherein the control unit acquires the output of the sensor while seat arrangement is being performed in the vehicle, and
wherein the control unit transmits a command to stop the seat arrangement to the vehicle when the control unit determines that there is a body of matter on a seat that operates with the seat arrangement based on the output of the sensor.

7. The information processing device according to claim 1,
wherein the control unit acquires the output of the sensor while seat arrangement is being performed in the vehicle, and
wherein the control unit transmits a command to prohibit an operation of a seat on which there is a body of matter to the vehicle, when the control unit determines that there is the body of matter on any of the seats based on the output of the sensor.

8. The information processing device according to claim 1, wherein the control unit acquires image data captured by a camera, as the output of the sensor.

9. The information processing device according to claim 1, wherein the control unit acquires an output of a seating sensor that outputs in accordance with a pressure applied to a seat, as the output of the sensor.

10. An information processing method wherein a computer executes:
acquiring an output of a sensor that detects a body of matter on each of seats of a vehicle; and
transmitting information regarding a permitted seat arrangement to a user terminal based on the output of the sensor.

11. The information processing method according to claim 10, wherein the computer transmits the information regarding the permitted seat arrangement to the user terminal, based on the output of the sensor and a relationship between the output of the sensor and the permitted seat arrangement, the relationship being stored in a storage unit.

12. The information processing method according to claim 10, wherein the computer sets a seat on which the body of matter is not detected as a seat that is able to be operated and sets a seat on which the body of matter is detected as a seat that is not able to be operated, and generates the information regarding the permitted seat arrangement.

13. The information processing method according to claim 10, wherein when the body of matter is detected in any of the seats, the computer sets all the seats as seats that are not able to be operated, and generates the information regarding the permitted seat arrangement.

14. The information processing method according to claim 10, wherein when the computer transmits the information regarding the permitted seat arrangement to the user terminal and then receives information regarding a request for seat arrangement from the user terminal, the computer transmits a command to the vehicle to perform the seat arrangement in accordance with the request.

15. The information processing method according to claim 10,
wherein the computer acquires the output of the sensor while seat arrangement is being performed in the vehicle, and
wherein the computer transmits a command to stop the seat arrangement to the vehicle when the computer determines that there is a body of matter on a seat that operates with the seat arrangement based on the output of the sensor.

16. The information processing method according to claim 10,
wherein the computer acquires the output of the sensor while seat arrangement is being performed in the vehicle, and
wherein the computer transmits a command to prohibit an operation of a seat on which there is a body of matter to the vehicle, when the computer determines that there is the body of matter on any of the seats based on the output of the sensor.

17. The information processing method according to claim 10, wherein the computer acquires image data captured by a camera, as the output of the sensor.

18. The information processing method according to claim 10, wherein the computer acquires an output of a seating sensor that outputs in accordance with a pressure applied to a seat, as the output of the sensor.

19. A system comprising:
a vehicle that includes a sensor that detects a body of matter on each of seats; and
a server that transmits information regarding a permitted seat arrangement to a user terminal based on an output of the sensor.

20. The system according to claim 19, wherein the server further includes a storage unit that stores a relationship between the output of the sensor and the permitted seat arrangement.
